(19) United States
(12) Patent Application Publication
(10) Pub. No.: US 2003/0020406 A1
(43) Pub. Date: Jan. 30, 2003

(54) Lamp electrode with carrier

(76) Inventor: Ludwig P. Kiermaier, Edison, NJ (US)

Correspondence Address: Thomas L. Adams, 120 Eagle Rock Avenue, P.O. Box 340, East Hanover, NJ, 07936, US

(21) Appl. No.: 09/917,343

(22) Filed: Jul. 30, 2001

(51) Int. Cl. H01J 17/18

(52) U.S. Cl. 313/625

(57) ABSTRACT

A lamp electrode is adapted to sustain bombardment from a stream of charged particles during an assembly process. The electrode has a mercury-dispensing carrier mounted on a non-conductive collar that is attached to the distal end of a metallic electrode shell. The carrier is arranged to deliver mercury upon heating. The carrier is spaced from the metallic shell by an offset distance in order to avoid premature mercury delivery from the carrier during bombardment of the shell during the assembly process.

### BACKGROUND OF THE INVENTION

1. Field of the Invention

The present invention relates to discharge lamps, and in particular, to apparatus and techniques for delivering a dose of mercury or like material into a sealed discharge chamber of a lamp.

2. Description of Related Art

Conventional gaseous discharge lamps as shown in FIG. 1 employ a metallic electrode in the form of a tubular shell 10 that is open at the distal end and closed at the proximal end. Shell 10 is typically fitted at its open distal end with a non-conductive ceramic collar 12. The proximal end of shell 10 is supported at the hairpin turn of supporting electrical leads 11, whose two legs are embedded in a pinch seal 14 made in discharge tube 16, which is a tubular glass body. Tube 16 is typically fabricated in the field by fusing both ends of a long tube to a pair of short tubes that are provided by a manufacturer as part of an electrode assembly.

A rear tube 18, which is part of the electrode assembly, is fused at pinch seal 14 to communicate with the interior of discharge tube 16. The rear tube 18 is fused at location 19 to a loading tube 20 having a bulbous chamber 22 containing a drop of mercury 24. A technician assembling a lamp can fuse tube 20 to the end of end tube 18, insert mercury drop 24 with a syringe, and its rear will initially remain open to serve as an evacuation tube. Tube 20 is shown coupled to a process manifold 25, which can evacuate tube 17.

Discharge tube 16 is normally filled with an inert gas and mercury vapor. Before loading these fill gases, electrode shell 10 is bombarded with charged particles in the usual fashion in a partial vacuum. Thereafter, working with the process manifold 25 shown coupled to tube 20, a greater vacuum is pulled in tube 16 before loading an inert gas and tipping off the loading tube 20. Tube 16 is then tilted to load mercury drop 24 into tube 16, before tipping off rear tube 18 near the pinch seal 14.

A disadvantage with this procedure is the time required by a skilled technician. Also, the technician runs the risk of contacting the mercury, which is considered a hazardous material.

In U.S. Pat. No. 2,288,253 mercury is loaded in a lamp by opening a closed metal or glass container located in a discharge tube, with a high frequency heater coil. The glass containers have a metal element that can be heated in order to fracture the glass. A disadvantage with this design is the placement of the container next to the supporting glass stem so that the mercury container may be prematurely heated and opened during formation of, or heat sealing to, the stem. Consequently, the mercury vapor may be pumped out when the discharge tube is subsequently evacuated (in preparation for filling with an inert gas). This not only reduces the amount of mercury, but also can also foul the vacuum pump and present an environmental hazard.

U.S. Pat. No. 4,924,145 recognizes that a metal capsule containing mercury may be prematurely opened by the heat used to form a press seal around a glass stem in a fluorescent lamp. Instead of mounting the mercury capsule on a wire attached directly to the glass stem (FIG. 1), the capsule is mounted on a coil located in the center of the discharge tube (FIG. 4). However, that central location can prevent uniform illumination along the length of the device.

In U.S. Pat. No. 4,539,508 a metal container containing mercury or a mercury alloy is supported on a wire that is mounted in the glass stem of a discharge lamp to extend in front of an electrode filament. A discharge current in the lamp chamber flows through the container to release the mercury. Thereafter a temporary jumper between the support wire and the electrode filament is broken by a short current pulse. Again, the capsule is mounted on a support wire mounted directly on the glass stem.

In U.S. Pat. No. 4,553,067 a mercury containing target such as a disk of Ti₃Hg is mounted on an electrical lead between a glass stem and a filament electrode. This electrical lead is embedded in the glass stem and extends outside the lamp so that a high voltage can be applied between the target and the filament electrode. This high voltage bombards the target with charged particles to release the mercury. Again, this target is in a location where it can prematurely release mercury due to the heat produced during formation of the glass stem. In a similar design in U.S. Pat. No. 5,754,000 a mercury dispensing head is mounted on an electrical lead to allow bombardment of the head. Other arrangements include conductive heating of the head, movement of a mercury dispensing substance from an exhaust tube to a cup, a sealed container of mercury dispensing substance, etc. In all of these arrangements the mercury dispensing material is kept adjacent to either the electrode or a pinch seal. See also U.S. Pat. No. 3,297,898 showing an open cup located between an electrode and a press seal.

In U.S. Pat. No. 4,534,742 a wire attached to a filament lead in a fluorescent lamp supports a glass capsule at a location in front of the filament. Mercury inside the capsule is released by a pair of incandescent lamps that are focused on the capsule to melt an opening in it. A difficulty with this design is the inadequate support of the capsule by a wire loop encircling the capsule. The wire loop is attached to a lead embedded in the lamp base. Heat produced during processing or assembly of the base can heat and expand the wire loop so that the capsule will tend to slip out of the loop.

Other designs have mounted capsules in various ways, but have placed the mercury delivery device at or behind the electrode. Locations near a supporting glass stem will be vulnerable to the heat produced during formation or heat sealing of the stem. Locating the capsule close to the electrode exposes the capsule to the heat generated there, especially for non-filament electrodes (e.g., non-heated or cold cathodes such as in FIG. 1). The non-filament designs are normally bombarded during processing and assembly, which produces greater heat than that occurring with the processing conducted with filament electrodes in flourescent lamps. See also U.S. Pat. No. 5,256,935 (mercury alloy placed on cold cathode);

For the heated filaments of fluorescent lamps, mercury capsules have been mounted on or at a filament shield. For induction heating of a wire that lies across and cuts into a glass capsule mounted on a filament shield, see U.S. Pat. Nos. 3,764,842; 3,794,402; and 5,801,482. See also U.S. Pat. No. 5,394,056 (glass capsule mounted at filament is opened when external current is applied to heater-cutter wire). For a glass capsule mounted on a filament shield and containing a wire that is heated by RF induction to crack the glass, see U.S. Pat. Nos. 4,182,971 and 4,335,326. For a metal capsule on a filament shield that is opened by RF induction, see U.S. Pat. Nos. 4,056,750 and 4,282,455.

See also U.S. Pat. Nos. 2,283,189 and 2,322,421 (metal container of mercury opened by the heat of the filament electrode of a discharge lamp); as well as U.S. Pat. No. 2,415,895 (metal container behind an electrode and attached to one of its lead wires can be heated by a high frequency coil to crack open a glass ampoule containing mercury). For metal capsules containing mercury that are placed next to a filament electrode, see U.S. Pat. Nos. 4,754,193; 4,823,047; 4,870,323; and 5,278,473. For mercury containing capsules placed near the base of an indicator tube, see U.S. Pat. Nos. 2,991,387; 3,300,037; 3,684,345 and 3,895,709.

In U.S. Pat. No. 4,288,715 a dual chamber, metallic container can be mounted on the glass stem of a discharge lamp. One of these chambers is open and contains an amalgam, while the other chamber is initially closed but later opened by a high frequency field to release the mercury therein. See also U.S. Pat. No. 4,393,325 (amalgam in open metal capsule is placed between close fitting glass walls of discharge lamp).

In European Patent Specification 63,393 an amalgam in a metal container is attached to the filament lead of a discharge lamp. The container is located next to a glass stem so that amalgam spills onto the stem when the container is drilled opened with a laser beam. See also U.S. Pat. No. 3,898,511 (amalgam on back of heat shield located behind filament electrode).

In U.S. Pat. No. 3,657,589 a mercury-releasing getter device employs intermetallic compounds of mercury. The compound is loaded into a groove in an annulus and embedded on a shield surrounding the electrode filament of a fluorescent lamp. The compound can later be heated by a high frequency induction heater. In still other embodiments the compound is formed into a pellet around a heater wire for direct heating. This reference does not disclose techniques for appropriate mounting and positioning of the compound to avoid premature delivery of mercury caused by heat generated during lamp processing and assembly. For other applications of this compound, see U.S. Pat. Nos. 3,728,004 and 4,308,650.

In U.S. Pat. No. 3,983,439 a metal plate having a “FIG. 8” shape supports a metal cup containing mercury. The plate is snapped into place at an indentation in the exhaust tube of a fluorescent lamp. After the lamp is processed the plate and its cup are heated to release the mercury. See also U.S. Pat. Nos. 4,907,998. A difficulty with placing metal containers in an exhaust tube is that they are usually in close proximity to the exhaust tube. Consequently, they must be made fragile enough to rupture when subjected to heat without melting the exhaust tube. This renders a metal container more prone to leakage due to handling. In U.S. Pat. No. 3,913,999 (U.K. Patent Specification 1,419,098) a metal tube is formed by cold weld nipping, but this flares the ends of the tube. This requires the relatively large exhaust tube 18 shown in FIG. 2 and still places metal components in close proximity to the glass exhaust tube.

In U.S. Pat. Nos. 5,917,276 and 6,048,241 a glass capsule containing mercury is placed in a tube projecting from the discharge vessel of a mercury discharge lamp. A laser is used to swell the glass capsule and hold it in place before another laser beam melts an opening in the capsule. The timing of the heating cycle and the composition of the glasses must be carefully controlled to avoid puncturing the exhaust tube.

In U.S. Pat. No. 2,280,618 an amalgam is placed within a discharge tube at a distance from the electrodes. The amalgam is located in or at a side tube or inside a hollow perforated glass sphere. The amalgam maintains the partial pressure of mercury or other vapor at a desirable equilibrium value. The amalgam is not delivered by opening a closed container located inside the discharge tube, See also, U.S. Pat. No. 5,294,867.

In U.S. Pat. No. 3,957,328 an unencapsulated amalgam located in the exhaust tube of a discharge lamp is heated to release mercury vapors. Thereafter, the exhaust tube is tipped off near the lamp base to separate the amalgam, which is thereby sealed in a glass capsule that can be discarded. One difficulty is the need to keep the amalgam cool during lamp processing, and for this purpose, a cooling gas stream must be blown around the section of the tube containing the amalgam.

In U.S. Pat. No. 4,145,634 pellets of amalgam are freely distributed along the length of a fluorescent lamp tube and can be used as a means for delivering an initial dose of mercury during assembly. These arrangements adversely affect the package outline (side tubes) or block the light output from the discharge tube (coils or pellets located along the length of the discharge tube).

Amalgams have been placed in the tubular tip off region of solenoidal electric field (SEF) lamps. These lamps do not employ electrodes that are processed by bombardment and therefore have different design issues. The amalgam should be kept at a designated position in order to maintain a proper operating temperature. An amalgam must also be kept away from a melting tip during tipping off. For example, a springy tail or tight fitting cylindrical screen maintains the amalgam location in U.S. Pat. Nos. 4,499,400 and 4,528,209. In U.S. Pat. No. 5,629,584 glass balls and dimples (or tilting to slide an amalgam) maintain proper spacing of an amalgam in an exhaust tube of an SEF lamp. See also U.S. Pat. No. 5,751,110 (amalgam placed in open glass container located in exhaust tube of SEF lamp); U.S. Pat. No. 5,739,633 (glass rods maintain amalgam spacing in intermediate tip off region of fluorescent lamp); U.S. Pat. No. 5,994,837 (tube opening into discharge chamber of electrodeless, high frequency discharge lamp contains an amalgam and an amalgam-coated wire extending from the tube). In any event, these designs do not incorporate a container that opens after being sealed into a discharge tube in order to deliver a dose of mercury vapor in a lamp. Instead, these designs are concerned with regulating the partial pressure of the mercury vapor during normal lamp operation.

In U.S. Pat. Nos. 3,898,720; 4,020,378; 4,105,910; and 4,698,549 an amalgam is placed on the glass stem supporting the electrode in a fluorescent lamp, but amalgams so positioned will tend to be overheated if fused to the main discharge tube during lamp assembly. See also U.S. Pat. No. 5,841,220 (amalgam is placed on a wire supporting a lamp electrode at a location adjacent the electrode or at a location between the electrode and the glass supporting stem); and U.S. Pat. No. 5,814,936 (amalgam placed in open metal container attached to supply lead of filament electrode (or to glass core in a high frequency, electrodeless lamp)).

See also U.S. Pat. Nos. 4,691,141; 4,767,965; 5,022,882; 5,057,743; and 5,200,233.

### SUMMARY OF THE INVENTION

In accordance with the illustrative embodiments demonstrating features and advantages of the present invention, there is provided a lamp electrode adapted to sustain bombardment from a stream of charged particles during an assembly process. The lamp electrode has a metallic shell having a distal and a proximal end. Also included is a non-conducting collar attached to the distal end of the shell. The lamp electrode also has a carrier mounted on the collar. The carrier is arranged to deliver mercury upon heating of the carrier. The carrier is spaced from the metallic shell an offset distance in order to avoid mercury delivery from the carrier during bombardment of the shell during the assembly process.

By employing apparatus of the foregoing type an improved electrode can be achieved. In a preferred embodiment the distal end of an electrode shell is fitted with a ceramic collar. A mercury dispensing carrier can be mounted on this collar. Because the preferred collar is an electrical insulator, current is less likely to flow through the carrier during bombardment of the electrode shell. Also, the preferred ceramic collar will be a relatively good thermal insulator so that heat generated during bombardment of the electrode shell will not readily conduct to the carrier and prematurely release mercury.

In one preferred embodiment, a mercury dispensing substance is placed in cylindrical cavities in the preferred ceramic collar. This substance may be a porous metal that holds mercury within its pores. After lamp processing, including bombardment, the porous metal can be heated by, for example, an induction heater to release the mercury.

In another preferred embodiment a metal capsule containing mercury can be secured by an adhesive to the ceramic collar. As before, an induction heater or the like can heat the metal capsule to release the mercury.

In still another preferred embodiment, a metal support wire is attached to the preferred ceramic collar. The wire extends inwardly to a position in front of the shell, where it supports a capsule containing mercury. The capsule will have an adequate spacing from the electrode shell and the glass base supporting the shell to avoid excessive heating that may prematurely open the capsule.

In some instances the distal end of the support wire is embedded in an insulating plug that is mounted in one end of a metal receptacle containing the mercury. In other instances the support wire is embedded in a glass capsule containing the mercury. The support wire may extend the full length or only part of the length of the glass capsule.

### BRIEF DESCRIPTION OF THE DRAWINGS

The above brief description as well as other objects, features and advantages of the present invention will be more fully appreciated by reference to the following detailed description of presently preferred but nonetheless illustrative embodiments in accordance with the present invention when taken in conjunction with the accompanying drawings, wherein:

FIG. 1 is a longitudinal sectional view of a discharge tube containing a tubular electrode shell with a rear tube fused to a loading tube containing a quantity of mercury, in accordance with the prior art;

FIG. 2 is an end view of a collar on an electrode of the type shown in FIG. 1, but modified to include a cavity containing a mercury dispensing carrier in accordance with principles of the present invention;

FIG. 3 is his side view of the collar of FIG. 2 removed from the electrode shell;

FIG. 4 is a detailed, fragmentary, longitudinal sectional view of the collar of FIG. 3 showing the carrier within a cavity;

FIG. 5 is a fragmentary, perspective view of an electrode shell and collar showing with an exploded view of a carrier that is an alternate to that of FIG. 4;

FIG. 6 is a detailed, longitudinal sectional view of the carrier of FIG. 5, assembled and cemented onto the collar;

FIG. 7 is a fragmentary, side view of the collar and electrode of FIG. 5 modified to include an alternate carrier (portions of the carrier broken away for illustrative purposes);

FIG. 8 is an end view of the collar of FIG. 7 taken along line 8-8 of FIG. 7;

FIG. 9 is a fragmentary view of a carrier (in partial longitudinal section) that is an alternate to that of FIGS. 7 and 8;

FIG. 10 is a fragmentary view of a carrier (in partial longitudinal section) that is an alternate to that of FIGS. 7-9;

FIG. 11 is a fragmentary view of a carrier (in partial longitudinal section) that is an alternate to that of FIGS. 7-10; and

FIG. 12 is a side view, partly in section, showing the shell and container of FIG. 5 supported on electrical leads that are embedded in a pinch seal of a discharge tube.

### DETAILED DESCRIPTION OF THE PREFERRED EMBODIMENTS

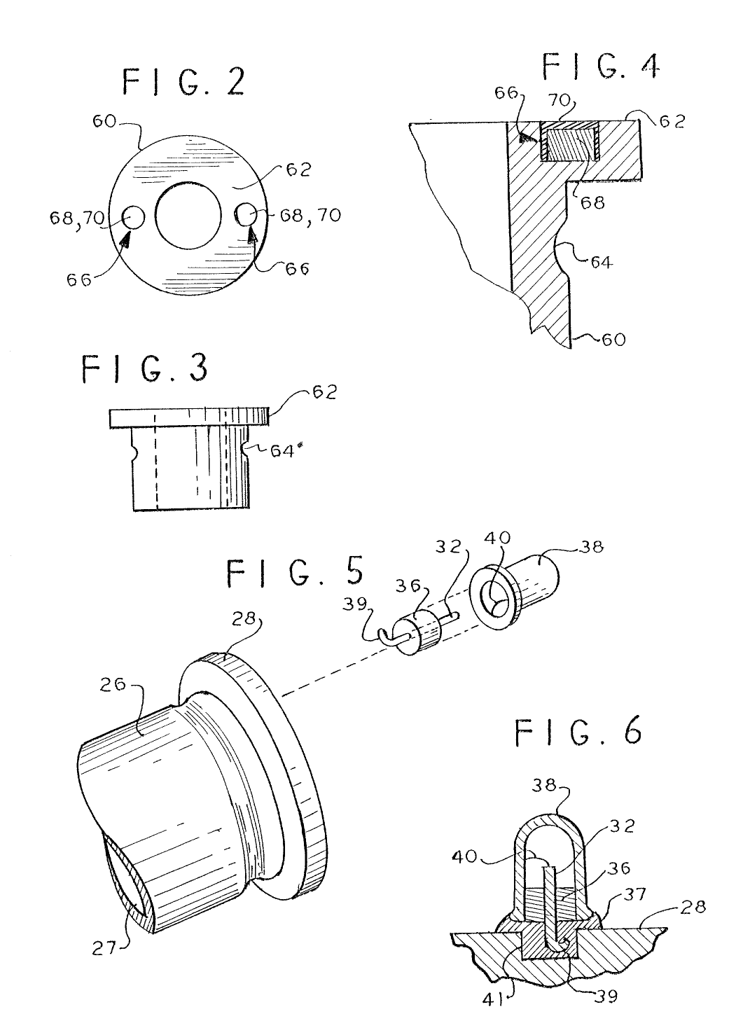

Referring to FIGS. 2-4, non-conductive collar 60 is for the most part a hollow ceramic cylinder with a distal flange 62 and an annular groove 64 for facilitating crimping of an electrode shell onto the collar. Molded onto the face of flange 62 is a pair of distally facing cavities 66. Fitted within cavities 66 are carriers in the form of cylindrical pellets 68 held in place with ceramic cement 70. The substance of pellet 68 may be a porous metallic structure having mercury or a mercury alloy in its pores in accordance with U.S. Pat. No. 4,808,136.

In some embodiments the size of flange 62 can be altered to accommodate carriers having a different size. In other embodiments, a different number of carriers can be installed in flange 62. Moreover in some cases the cavities in flange 62 will be relatively shallow so that the carrier will protrude from the cavity. In still other embodiments, the flange will not have any cavities and the carrier will simply be secured to the face of the flange 62 by cement or by other fastening means.

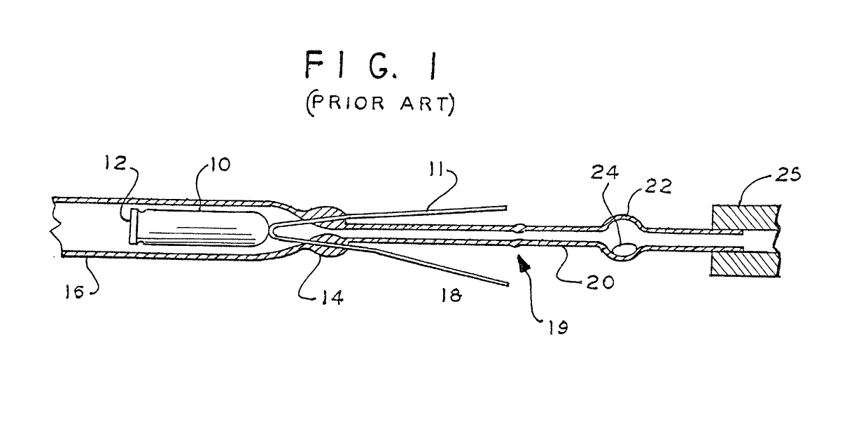

Referring to FIGS. 5 and 6, electrode shell 26 has a hollow cylindrical shape similar to that shown in FIG. 1 for shell 10. As with the electrode shell of FIG. 1, the inside 27 of shell 26 is coated with a conventional emission enhancing coating. Non-conductive ceramic collar 28 is fitted in the distal end of shell 26 and is crimped in place.

A mercury dispensing carrier is shown herein as a container formed from electrically non-conductive, glass plug 36 and electrically conductive receptacle 38. Plug 36 is shown with an optional conductive element, namely wire 32 whose outside end is formed into optional hook 39. Wire 32 and plug 36 seal the open end of receptacle 38 and capture therein a quantity of mercury 40 (herein referred to as a substance for delivering mercury). Mercury 40 may be surrounded by an inert gas or may be held in a vacuum. While mercury 40 is preferably in a simple liquid form, in other embodiments substance 40 may be a mercury alloy or a mercury compound that can be heated to release mercury vapor.

Receptacle 38 is shown in FIG. 6 secured to the distal face of ceramic collar 28 by ceramic adhesive 37. A cavity 41 is formed in collar 28 to receive and securely hold the hook 39 in wire 32 of receptacle 38. In other embodiments receptacle 38 may be held in place by clips or other fastening means.

Referring to FIG. 12, previously mentioned receptacle 38 is again shown secured to ceramic collar 28 which is crimped in the open distal end of shell 26. The proximal end of shell 26 is supported at the hairpin turn of supporting electrical leads 31, whose two legs are embedded in a pinch seal 33 made in discharge tube 29, which is a tubular glass body. Tube 29 is typically fabricated in the field by fusing both ends of a long tube to a pair of short tubes that are provided by a manufacturer as part of an electrode assembly. The embodiment of FIG. 12 does not have an evacuation tube as shown in FIG. 1. Such a configuration lacking an evacuation tube is sometimes referred to as a “dud” electrode. Any processing such as pulling a vacuum and re-filling with an inert gas will therefore be done at the opposite end where an evacuation tube is located. It will be appreciated that for some embodiments a mercury-dispensing receptacle 38 may be located at both ends of the discharge tube. Therefore, some electrode assemblies will have both an evacuation tube and a mercury-dispensing receptacle.

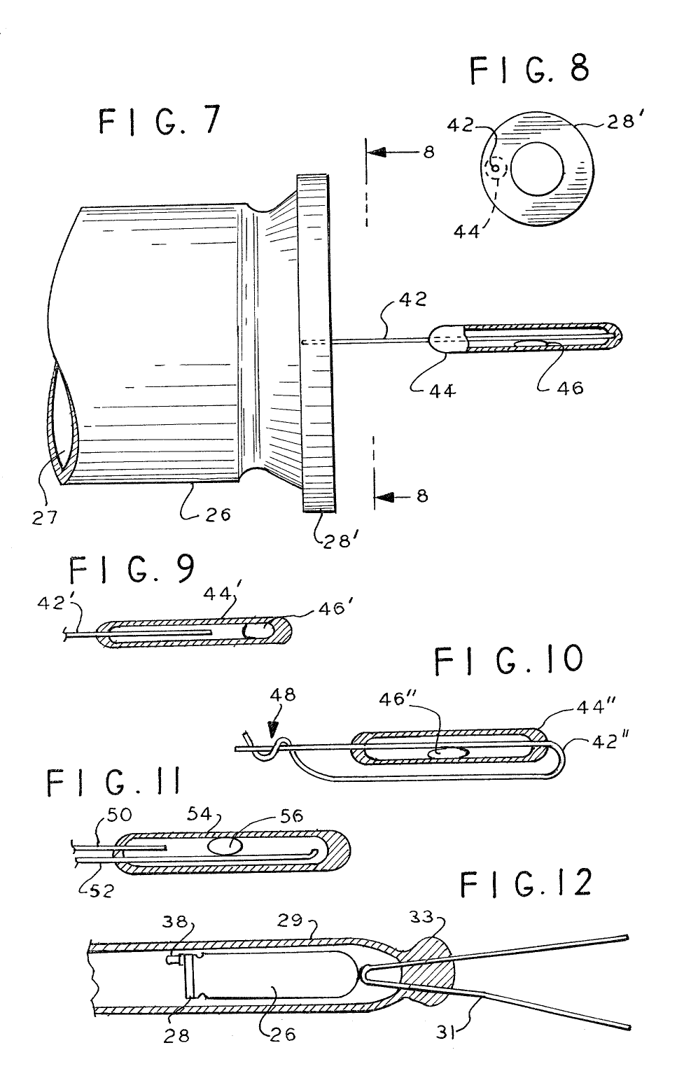

Referring to FIGS. 7 and 8, electrode shell 26 is identical to the one shown in FIG. 5 and therefore uses the same reference numeral. Non-conductive ceramic collar 28′ is fitted in the distal end of shell 26 and is crimped in place. Preferably, collar 28′ will have a narrow cavity size to hold a conductive element, namely wire 42. Wire 42 can be glued in place or force fit into this cavity.

Wire 32 is held in a bore in collar 28′ formed by molding, drilling, or the like. Wire 42 may be secured in collar 28′ by gluing, a force fit, etc. Wire 32 is parallel to the axis of shell 26, which is for the most part a hollow cylinder.

Wire 32 is part of a mercury-dispensing carrier which includes glass container 46. Wire 42 is embedded in glass container 44, which contains mercury 46 (container 44 shown in phantom in FIG. 8). Glass container 44 may be fabricated by placing a wire inside a short length of glass tubing that contains a drop of mercury before applying heat to either end of the glass tubing in order to seal the tubing to the wire to form a package as illustrated.

Referring to the alternate glass container of FIG. 9, components corresponding to those previously shown in FIG. 7 have the same reference numeral but marked with a prime. Glass container 44′ is closed at both ends and contains mercury 46′. Wire support 42′ is sealed at one end of container 44′ and extends into the inside of container 44′ without extending its full length. Thus, the distal end of support wire 42′ is free and the distal end of container 44′ does not have a wire embedded therein.

Referring to the alternate glass container of FIG. 10, components corresponding to those previously shown in FIG. 7 have the same reference numeral but marked with a double prime. Wire support 42″ extends through the full length of glass container 44″. Both ends of glass container 44″ are sealed on wire support 42″ to contain mercury 46″. The distal end of support wire 42″ doubles back and is twisted onto itself at location 48 to form a loop. As explained further hereinafter, this loop can enhance the electromagnetic coupling to an RF induction heater.

Referring to FIG. 11, a pair of side-by-side support elements in the form of wires 50 and 52 are attached by their proximal ends (not shown) to the previously mentioned ceramic collar (collar 28′ of FIG. 7). Glass container 54 is tubular and is sealed at its distal end, while its proximal and is sealed around support wires 50 and 52. Support wire 50 extends into the interior of glass container 54 a short distance, while support wire 52 extends almost the full length of container 54 without being embedded in the distal end of the container. The distal end of the wire 52 is bent inwardly and provides a backstop for mercury drop 56. Constructed in this fashion, the device of FIG. 11 is essentially the same as a miniature mercury switch. In some embodiments a stock mercury switch may be attached to the previously mentioned collar 28′.

To facilitate an understanding of the principles associated with the foregoing apparatus, its operation will be briefly described in connection with the embodiment of FIGS. 7-8 and 12. Shell 26 is normally provided from a manufacturer inside a short glass tube supported on electrical leads 31 embedded in a pinch seal 33 (“dud” electrode of FIG. 12). The assembly will also use a second short glass tube containing another electrode shell similar to that shown in FIG. 1, but without the loading tube 20 (that is, with just an open exhaust tube 18). These short glass tubes (dud and exhaust electrodes) are fused to either end of a longer discharge tube. The end with the open exhaust tube (i.e., exhaust tube 18 of FIG. 1 without loading tube 20).

This open exhaust tube will be used to partially evacuate the discharge tube. Next, a high voltage will be applied between the electrodes at the opposite ends of the discharge tube to produce a stream of charged particles to heat the electrodes and the discharge tube in the usual fashion. As a result, any moisture in the lamp components will be driven into a vapor state. In addition, an emission-enhancing coating on the inside 27 of electrode 26, typically a mixture of metal carbonates or peroxides (or both), are converted to the corresponding oxides (sintering).

The flux of charged particles flowing during bombardment is concentrated primarily on electrode shell 26 since it has the greatest conducting surface. Also, the emission enhancing coating on the inside 27 of shell 26 reduces the work involved in electron transfer, so that current flow predominates on the inside 27 of the shell 26, especially as the carbonates and peroxides in the coating are converted to their corresponding oxides. For this reason, little current will tend to flow elsewhere.

More importantly, current will not flow in wire 42 since it is insulated from shell 26 by ceramic collar 28′. Also, the offset distance of capsule 44 may be adjusted to reduce any temperature rise in support wire 42. The offset distance may be large enough so that the radiant heat of shell 26 does not substantially affect capsule 44. After bombardment a greater vacuum will be pulled before loading an inert gas and then tipping off the exhaust tube to seal the discharge chamber.

An R.F. induction coil (not shown) may now be brought near capsule 44 to generate an eddy current in support wire 42. This heats mercury 46 to raise the pressure inside capsule 44. Also, thermal expansion of support wire 42 stresses both ends of the capsule 44. These factors will crack capsule 44 and mercury 46 will vaporize and leak from the capsule. In some cases the glass capsule 44 can be opened by an intense radiation beam. For example, a laser beam can be used to melt a hole in glass capsule 44.

For embodiments employing capsule 44′ (FIG. 9), capsule 44″ (FIG. 10), or capsule 54 (FIG. 11) the foregoing procedures are essentially the same. For capsule 44″ support wire 42″ is formed into a loop. Therefore, an RF induction coil that produces magnetic flux perpendicular to the plane of this loop will provide a high degree of coupling, causing greater eddy currents to circulate in the loop.

For the embodiment of FIG. 5 receptacle 38 can be opened by an RF induction heater or other radiation source. This radiation can heat receptacle 38 and wire 32 to raise the vapor pressure inside the container. In some instances a focused beam of radiation may melt a hole in the side of receptacle 38. In any event, receptacle 38 will open and vaporized mercury 40 will be delivered into the discharge tube.

In some embodiments, the wire 32 will be eliminated. This design will provide greater thermal insulation so that the heat of bombardment will not readily travel along support wire 32 and run the risk of prematurely opening the container.

For the embodiment of FIGS. 2-4 an RF induction heater can heat carrier pellets 68. Because carrier 68 is made of a porous metal, eddy currents readily circulate to heat the carrier. The mercury or mercury alloy contained in the pores of carrier 68 are thereby vaporized to produce a pressure that ruptures cement 70. Alternatively, cement 70 may be applied around the edges of carrier 68 so that the released mercury vapor freely escapes though the porous cement 70.

It is appreciated that various modifications may be implemented with respect to the above described, preferred embodiment. For example, descriptions using the term mercury shall be deemed to include substances that have relevant properties similar to mercury in the context of a discharge lamp. The illustrated containers can be modified to employ various types of materials, having various shapes and sizes. depending upon the desired heat sensitivity, the amount of mercury to be dispensed, structural integrity, etc. The ceramic collar may have a distal end with an annular trough for holding a carrier. Alternatively, the collar may have a number of outwardly projecting cups, clips or hooks for holding the carrier. In still other embodiments separate cups, troughs, or other devices may be attached to the distal end of the collar and loaded with a carrier. Furthermore, the previously mentioned porous metal may be shaped as a flat washer that is secured to the distal face of the collar. Alternatively, this porous metal can be molded around a wire stub that is then mounted in a mating hole in the collar. Moreover, the carrier can be attached to various exposed surfaces of the collar, and not just the distally facing surface.

Obviously, many modifications and variations of the present invention are possible in light of the above teachings. It is therefore to be understood that within the scope of the appended claims, the invention may be practiced otherwise than as specifically described.

1. A lamp electrode adapted to sustain bombardment from a stream of charged particles during an assembly process, comprising:
a metallic shell having a distal and a proximal end;
a non-conductive collar attached to the distal end of said shell; and
a carrier mounted on said collar, said carrier being arranged to deliver mercury upon heating of said carrier, said carrier being spaced from said metallic shell an offset distance in order to avoid mercury delivery from said carrier during bombardment of said shell during the assembly process.

2. A lamp electrode according to claim 1 wherein said collar has a distally facing cavity, said carrier being located in said cavity.

3. A lamp electrode according to claim 1 wherein said carrier comprises:
a porous metallic structure having liquid mercury or a mercury alloy retained therein.

4. A lamp electrode according to claim 3 wherein said collar has a distally facing cavity, said porous metallic structure being located in said cavity.

5. A lamp electrode according to claim 4 wherein said porous metallic structure is cemented in place in said cavity.

6. A lamp electrode according to claim 4 wherein said carrier is a container.

7. A lamp electrode according to claim 6 wherein said container has mercury inside.

8. A lamp electrode according to claim 6 wherein at least part of said container is electrically conductive.

9. A lamp electrode according to claim 6 comprising:
a plug mounted in an end of said container; and
a conductive element embedded in said plug.

10. A lamp electrode according to claim 9 wherein said plug is electrically non-conductive.

11. A lamp electrode according to claim 6 wherein said container comprises glass.

12. A lamp electrode according to claim 6 comprising:
conductive element extending into the container.

13. A lamp electrode according to claim 12 wherein said container is supported on said conductive element, said conductive element being mounted on said collar.

14. A lamp electrode according to claim 12 wherein said container is supported on said conductive element, said conductive element being cantilevered on said collar.

15. A lamp electrode according to claim 12 wherein the conductive element reaches across the length of the container.

16. A lamp electrode according to claim 12 wherein said conductive element comprises a wire.

17. A lamp electrode according to claim 12 wherein said conductive element comprises a side by side pair of elements.

18. A lamp electrode according to claim 12 wherein said conductive element comprises a loop passing through said container.
